(19) United States
(12) Patent Application Publication
(10) Pub. No.: US 2004/0186193 A1
(43) Pub. Date: Sep. 23, 2004

(54) Process for the production of polyurethane foams

(76) Inventors: Martin Schamberg, Sankt Augustin (DE); Reiner Raffel, Siegburg (DE); Jurgen Wirth, Koln (DE)

Correspondence Address: BAYER MATERIAL SCIENCE LLC, 100 BAYER ROAD, PITTSBURGH, PA, 15205, US

(21) Appl. No.: 10/800,908

(22) Filed: Mar. 15, 2004

(30) Foreign Application Priority Data
Mar. 18, 2003 (DE) 10311768.7

(51) Int. Cl. C08L 75/00; B32B 5/02; C08F 2/00

(52) U.S. Cl. 521/155; 422/133

(57) ABSTRACT

Polyurethane foams are continuously produced using CO₂ as the blowing agent and a filler. The filler is mixed with at least a portion of one of the reactive components and any agglomerates are virtually completely broken up during or subsequent to such mixing. The filler-containing mixture is passed through at least one filter element to filter out any oversize grains, residual agglomerates and/or impurities. The CO₂ is added under pressure to at least a portion of at least one of the reactive components to generate a mixture which comprises liquid CO₂ or a mixture which comprises liquid CO₂ and filler. This mixture is mixed with the other reactive component(s) and optionally further additives. The reactive mixture which includes CO₂ and filler is then decompressed by division into a plurality of individual streams at shear velocities above 500 s-1 and the flow velocities thus generated are reduced before discharge. The reactive mixture is then applied to a substrate and allowed to cure to form a polyurethane foam.

### BACKGROUND OF THE INVENTION

The present invention relates to a process and an apparatus for the production of foams, in particular polyurethane foams, from at least two liquid reaction components which react together, with fillers being admixed with at least one of these reaction components and liquid CO₂ being admixed as a physical blowing agent with at least one of these reaction components.

Processes for foaming with CO₂ as a physical blowing agent are described in EP-A-0767728, EP-A-0794 857 and EP-A-0645226, for example. A common feature of these processes is that a reactive mixture which comprises dissolved CO₂ is passed through relatively narrow (for example, round or elongate) openings, with the sudden change of pressure generated ensuring that the dissolved CO₂ passes from the dissolved state into the gaseous state.

It has been found, inter alia, that the following two essential physical boundary conditions or rules must be observed in order to produce a defect-free foam:

The decompression to ambient pressure of the reactive mixture which includes CO₂ must be completed within a very short time span. The rapidly growing cells must no longer be exposed to any greater mechanical loads once they have exceeded a certain size. If the decompression procedure takes place too slowly, the cells are exposed to the relatively high shear velocities which necessarily arise in the decompression body while still at a stage in which they are already too large and consequently too sensitive.

The frothy mixture must have as uniform a velocity as possible within as short a time as possible after decompression to atmospheric pressure. This means that the velocity peaks which inevitably arise in the decompression body must be dissipated with all possible speed. Once more, the rapidly growing cells should be exposed to the lowest possible mechanical loads. For this purpose, it is necessary that the viscous forces which are responsible for breaking down the velocity peaks be as great as possible in comparison to the pulse force of the reaction mixture leaving the decompression body.

Both marginal conditions are, in principle, observed most effectively when the reaction mixture which includes CO₂ is decompressed in a nozzle field composed of the greatest possible number of round holes of the greatest possible fineness. No other geometric arrangement makes the interrelationship between pressure dissipation, pressure dissipation time and velocity dissipation more favorable with regard to the above-mentioned criteria.

Against this background, the processing of fillers in the production of polyurethane foams having CO₂ as the blowing agent represents a major challenge. Limits are set to the fineness of the holes, dependent on the particle size range of the filler which is to be processed, so that the fine openings cannot clog even during hours of operation. A suitable process should therefore

1. enable a decompression body having openings of the greatest possible fineness to be used which approach as closely as possible the particle size range of the filler which is to be processed, without jeopardizing production reliability; and

2. as far as possible, meet the criteria indicated above, in particular a rapid decompression and the dissipation of the velocity peaks, with this given limit as to the fineness of the openings, by a suitable process regime and in particular also by suitable construction of the decompression body. The greater the success in this respect, the greater the proportion of the CO₂ which can be controlled by the process.

### SUMMARY OF THE INVENTION

It is an object of the present invention to provide a process and apparatus for the production of defect-free, filled polyurethane foams with CO₂ dissolved in at least one reaction component as the blowing agent.

This and other objects which will be apparent to those skilled in the art are accomplished by decompressing the reaction mixture containing filler and dissolved carbon dioxide by division of that mixture into a plurality of streams having shear velocities above 500 s⁻¹ and the flow velocities are reduced before that mixture is discharged for curing.

### BRIEF DESCRIPTION OF THE DRAWINGS

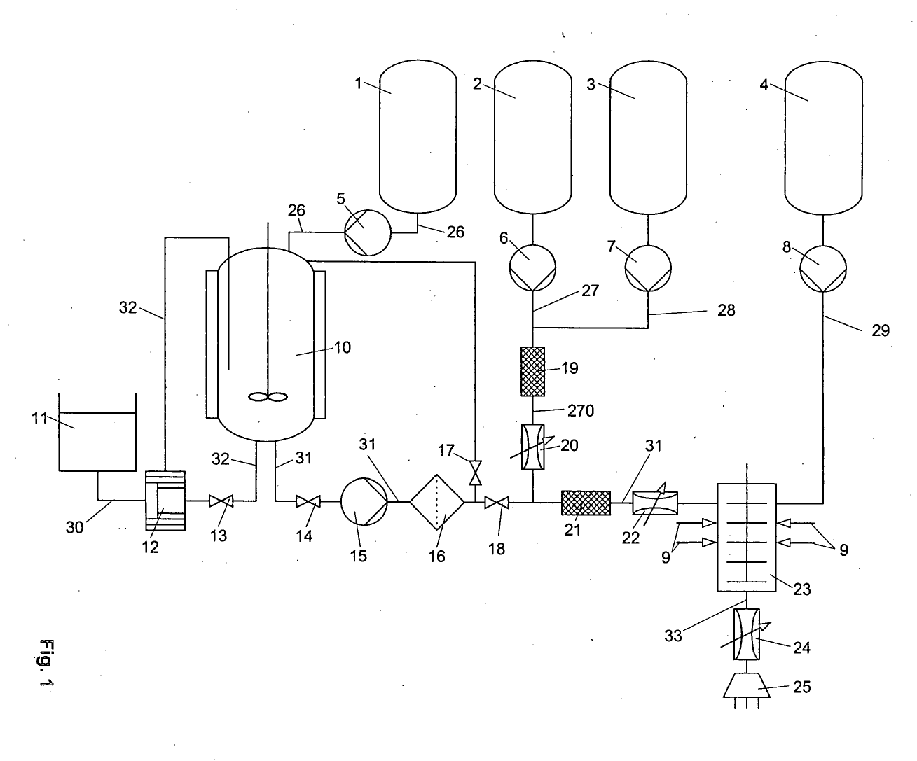

Each of FIGS. 1, 2 and 3 illustrates an apparatus suitable for the production of polyurethane foams in accordance with the present invention.

### DETAILED DESCRIPTION OF THE INVENTION

The present invention relates to a process for the continuous production of polyurethane foams with CO₂ as the blowing agent and with the admixture of fillers. In this process, the filler is admixed with at least one of the reactive components (e.g., isocyanate or polyol) or to a portion of one of the reactive components and this component or portion of the component is exposed to high shear velocities, either in direct manner when the filler is incorporated or following the admixture thereof, to virtually completely break-up the filler in the reactive component, so that a virtually agglomerate-free mixture is obtained. This mixture which includes filler is passed through at least one filter element to filter out oversize grains, residual agglomerates and impurities.

The CO₂ is added under pressure to one of the reactive components or to a portion of one of the reactive components or to the mixture which includes filler to produce a mixture which includes liquid CO₂ or a mixture which includes both liquid CO₂ and filler.

The mixture which includes CO₂ and the mixture which includes filler or the mixture which includes both liquid CO₂ and filler is mixed with the other reactive components and optionally further additives. The reactive mixture which includes CO₂ and filler is then decompressed by division of that mixture into a plurality of individual streams at shear velocities above 500 s⁻¹. The flow velocities thus generated are reduced before discharge.

The reactive mixture is then applied to a substrate and allowed to cure to form a polyurethane foam.

Suitable fillers are, for example, melamine, calcium carbonate powder, graphite powder, and recycled powder. Melamine and calcium carbonate powder are preferably used.

The lower the maximum size of the particles which must pass through the discharge body, the greater may be the selected fineness of the hole cross-sections of the filter. The maximum particle size which reaches the discharge body, with a given filler and at a given particle size distribution, can be limited reliably only by suitable filtering. The fineness of filter should approach as closely as possible the particle size range or, optionally, also fall within the particle range.

It has been found that the holes of the sieves in the discharge body can also become blocked by a plurality of oversize grains which are markedly smaller in all dimensions than the sieve holes themselves, if these grains flow simultaneously through one opening and become wedged together. For this reason, the statistical probability of this eventuality must be reduced to such a low level that even during hours of operation it rarely, if ever, arises. It has been found that the fineness of filter selected should ideally be so fine that in the case of round sieve holes, three particles, and in the case of elongate sieve holes, two particles, are able to pass through one hole simultaneously and in any arrangement.

This necessity can also be readily reconstructed in a theoretical examination. If a feed of 20 kg per minute of CaCO₂ having an average particle size of approximately 3 μm is visualized as processing a quantity of particles on the order of 10¹⁹ particles per second, then it becomes clear that even if critical oversize grain contents are within the ppm range, the statistical probability of a plurality of oversize grains flowing simultaneously through one hole is by no means negligible. Account must be taken here of the fact that in the case of such normal commercial chalks having an average particle size of less than 3 μm, a proportion of up to 0.1% having a particle size greater than 45 μm is present. In terms of the example provided above, this nevertheless means an oversize grain burden of well over 1000 particles per second having a particle size greater than 45 μm.

For this reason, the openings of the sieves are at least 1.2 up to a maximum of 10 times, in a preferred embodiment, 1.5 to 5 times, and in a particularly preferred embodiment 1.8 to 4 times as big, as the slots or holes of the finest filter stage.

It is clear from the numerical examples provided that it is advantageous to use filters which can be cleaned in continuous manner in order to be able to filter as finely as possible. A burden of more than 1500 particles per second means that over 5 million particles must be filtered out per hour. This quantity increases exponentially the size of the sieve openings needed for a given particle size range.

Plate-type edge filters, which are cleaned by means of a comb, or wire-type edge filters and slotted tube filters, which are cleaned by means of scrapers are, for example, considered suitable as the filters for this duty.

Filter elements composed of a perforated foil attached to a cylindrical supporting body and cleaned with the aid of a scraper are likewise suitable.

An embodiment which is particularly advantageous is that in which the openings of the perforated foil are constructed to be as sharp-edged as possible at the flow inlet, in order to enable the particles which have been filtered out to be captured as effectively as possible by the scraper. These openings become larger towards the outlet side. This ensures good mechanical cleanability of the filter elements and simultaneously minimal pressure loss.

It is also advantageous that filtering takes place with such two-dimensionally effective filters in at least one filter stage. Particles which have two dimensions that markedly exceed the fineness of the filter are able to pass through a one-dimensional filter stage. These may then block the openings of the discharge body despite the finer filtering.

It is highly advantageous for an optimal process regime if this two-dimensional filtering element is cleaned in continuous manner or at least at intervals. The perforated foils having, for example, round, square or hexagonal hole cross-sections, which have already been described above, are suitable for this purpose.

The embodiment of the filter zone as a filter cascade composed of a one-dimensional filtering element and a two-dimensional filtering element is advantageous. Here, the one-dimensional filtering element should preferably be flowed through first and should have finer openings than the two-dimensional filtering element.

It has been found that, for the same fineness of filter, filters having elongate openings, that is to say one-dimensionally effective filter elements, are able to process a higher burden (particles per unit of time) of oversize grains which must be filtered out per unit area of filter than two-dimensionally effective filter elements. It is therefore advantageous if the one-dimensionally effective filter removes the main burden of the oversize grains, and the subsequent two-dimensionally effective filter element substantially only filters out the elongate oversize grains.

In this cascade, at least the finer, one-dimensionally filtering element should be cleaned in continuous manner. However, it is better if both filters are cleaned in continuous manner, because the finenesses of the filters can be better optimized in this case with regard to the particle size range.

The particle size distribution of the filler which is to be processed is a decisive criterion for the selection of the fineness of filter. In the particle size distribution graphs which are generally plotted by filler manufacturers for specification of the filler, the y-axis relates to the percentage of particles having a particle size which lies below the particle sizes to which the x-axis relates. These distributions are generally determined today by means of laser diffraction spectroscopy, for example with instruments such as Cilas 920, Malvern 2600, and the like. Here, the particles are irradiated with monochromatic laser light. The rays are diffracted by the particles dependent on their size, and the intensity distribution of the diffracted light is measured with the aid of a suitable detector. The particle size distribution can then be determined from this intensity distribution of the light.

Because the fillers which are preferably used generally have a relatively widely scattered particle size range, it is difficult to specify the finenesses of filter with precision dependent on the particle size range.

However, the ∫top cut” which is frequently specified, for example in the case of calcium carbonate powders, that is to say the particle diameter which is greater than 98 wt. % of the filler particles, provides a reference point for sizing the fineness of filter. For every filler this can be read off from the particle size distribution curve.

It has emerged that the finest filter stage should be coarser by a factor of 1 to 10, preferably by a factor of 1.2 to 7 and most preferably by a factor of 1.5 to 5, than this measure of the top cut.

In order to enable the fineness of filter to be matched as finely as possible to the particle size range, it is moreover necessary for the filler to be present in virtually agglomerate-free manner in the mixture which is to be filtered. Otherwise, the particle size range in the region of the upper particle sizes is so unfavorably influenced, even by agglomerates which consist of only few particles, that the filter stages must be selected to be markedly coarser in order to ensure smooth running of the process.

The process must also be able to process reliably fillers which tend to form lumps as early as before incorporation in the dry state or even as a result of atmospheric humidity, and which are therefore completely wettable only with difficulty. When such agglomerates then contact the liquid into which they are to be incorporated, the agglomerate is wetted on the outside with the liquid and initially remains dry inside. The liquid must then, in the worst case, penetrate to the interior of this agglomerate by capillary forces and thereby also expel the accumulated air. Complete wetting of the individual particles and a complete breaking-up of the filler is, however, not achievable in this manner without the introduction of mechanical energy.

A suitable method for avoiding or breaking up agglomerates is exposing the highly viscous mixture to high shear velocities. For this, the mixture is exposed to shear velocities of between 10000 s⁻¹ and 200000 s⁻¹, preferably between 20000 s⁻¹ and 150000 s⁻¹ and most preferably between 30000 s⁻¹ and 100000 s⁻¹. Apparatus which work on the rotor-stator principle are particularly suitable for this purpose. A high-speed rotor generates very high shear velocities in a narrow gap between this rotor and a stationary stator and consequently induces shear stress in the mixture. This causes the agglomerates to be broken up and the individual particles can be wetted by the surrounding liquid.

Another possible way to achieve the high shear velocities is to atomize the mixture, for example through one or more perforated orifice plates. In this variant, however, atomization pressures on the order of from 30 to 200 bar are required, depending on the filler.

Addition of the filler in accordance with the process described in EP-A-373409 is also advantageous. Here, the filler is added to a metered liquid stream with the aid of a stuffing screw. The filler is in this case mixed with the liquid directly following the addition in a relatively low-volume continuous mixer and, supplementing the process described in EP-A-373409, is exposed to high shear velocities directly downstream. It is advantageous here that directly downstream of the small incorporation zone, the mixture is exposed by a rotor-stator system to such high shear velocities that virtually complete breaking-up is ensured. The wetting of all of the particles, which is complete from the outset, and the direct processing of the mixture prevents deposition phenomena and the formation of larger, dry unwetted zones in the pipe system.

As a result of these measures (the achievement of a virtually agglomerate-free mixture and optimized filtering which is matched to the particle size range), relatively fine openings can be used in the decompression body despite the filler.

These can nevertheless optionally be substantially coarser than the openings otherwise used in the CO₂ process, depending on the type of filler. This substantially has the following disadvantageous effect:

The velocities which must necessarily be generated during decompression of the reactive mixture which includes CO₂ are more difficult to settle, i.e., the velocity peaks are more difficult to dissipate. In particular, the ratio of the viscous forces (which lead to dissipation of the jet pulses because of the velocity gradients) to the jet pulse forces deteriorates markedly. The result of this is that the mixture is exposed to relatively high shear stresses longer and consequently at a stage of well advanced cell growth. As a result, defects may arise. In particular, the insufficiently dissipated jet pulses may give rise to outright occlusion holes when the froth mixture diverts.

Against this background it is increasingly important, as the openings become larger, to limit the velocity peaks of the jets as they leave. However, because high velocities are necessary for an abrupt pressure dissipation, these high velocities must be dissipated reliably before the mixture leaves the decompression body.

For this reason it is necessary to decompress the mixture in a plurality of stages, with the abrupt pressure dissipation substantially being achieved in the initial stages with generation of high shear velocities,-and in at least one stage which is connected downstream, the velocity peaks thereby generated being reliably dissipated. This is made possible, for example, by the use of sieves of different openness.

It has been found to be highly advantageous if the holes of the lower sieves are arranged consistently in mutually displaced manner, such that no holes of two consecutive sieves are mutually aligned. As a result, the jets are diverted upstream of each sieve, such that the high velocity peaks are dissipated reliably before the mixture leaves the decompressing bodies.

The present invention also relates to an apparatus useful for carrying out the process of the present invention.

The invention is explained in greater detail hereinbelow by reference to FIGS. 1, 2 and 3.

FIGS. 1, 2 and 3 each show an apparatus for the production of polyurethane foam having CO₂ as the blowing agent, during which filler is incorporated into one of the reaction components.

Each of the three figures illustrates 2 polyol vessels—the vessels labelled 1, 34, and 65 are for polyol 1; the vessels labelled 2, 35, and 66 are for polyol 2; a blowing agent vessel labelled 3, 36, and 67; and an isocyanate vessel labelled 4, 37, and 68 for the storage of the components. The associated feed pumps are labelled 5, 38, and 69 (for polyol 1); 6, 39, and 70 (for polyol 2); 7, 40, and 71 (for the blowing agent); and 8, 41, and 72 (for the isocyanate). The associated pipe system for transporting these components is labelled 26, 58, and 87 (for polyol 1); 27, 59, and 88 (for polyol 2); 28, 60, and 89 (for the blowing agent); and 29, 61, and 90 (for isocyanate) to the main mixer labelled 23, 55, and 84.

The metering lines for the further additives (vessels, pumps, pipes) are symbolized by the arrows 9, 42, and 73 into the main mixer.

All the Embodiment Examples furthermore comprise a storage or receiving container for the filler labelled 11, 44, and 74; a supply pipe for the filler labelled 30, 62, and 91 into the pipe system for the polyol 1 labelled 26, 58, and 87 as well as a mixture pump labelled 15, 47, and 78 for metering the polyol/filler mixture.

In all the Embodiment Examples (FIGS. 1 to 3) an apparatus for the comminution of agglomerates labelled 12, 46, and 77 is installed within the pipe system of the pblyol stream for polyol 1 (26, 58, and 87) in the region where the filler supply pipe (30, 62) opens into the main mixer (23, 55, and 84).

In this pipe section (31, 63, 92) a filter (16, 48, and 79) is moreover in each case illustrated, through which the filler-containing mixture is passed. This may also be constituted by a plurality of filter lines connected in parallel and having a plurality of filters connected in series. It is advantageous to use continuously cleanable filters.

The blowing agent is in each case added first to a second polyol stream and is brought under pressure into solution in this polyol stream with the aid of a static mixer (19, 51, 80) and an adjustable choke (20, 52, 81) both of which are arranged in pipe section (270, 590, 880) . The pressure should be adjusted with the aid of the adjustable choke (20, 52, 81), so that the blowing agent is dissolved as completely as possible when the choke is reached.

This blowing agent-containing solution is then mixed under pressure with the filler-containing mixture with the aid of a further static mixer (21, 53, 82) and a further adjustable choke (22, 54, 83). The pressure should here be adjusted with the aid of the choke (22, 54 and 83), so that the blowing agent remains dissolved as completely as possible.

The mixture which comprises filler and CO₂ is then mixed with the isocyanate and the additives in the main mixer (23, 55, 84) and is supplied to the discharge body (25, 57, 86) by way of a pipe (33, 64, 93) for the reactive mixture (33, 64, 93) which comprises filler and blowing agent.

In the discharge body (25, 57, 86) which is equipped with at least one fine-meshed sieve, the controlled pressure dissipation of the reactive mixture takes place with division of the mixture into a plurality of individual streams at shear velocities above 500 s⁻¹.

Between the main mixer (23, 55, 84) and the discharge body (25, 57, 86) a further adjustable choke body (24, 56, 85) is integrated into the pipe for the reactive mixture (33, 64, 93).

The differences between the processes which are illustrated in the three Figures lie in the type of addition and in the admixture of the filler, and are explained in greater detail hereinbelow.

In FIG. 1, a batch vessel (10) having a small loop pipe (32) is built in between the storage vessel for polyol 1 (1) and the mixture pump (15). The desired quantity of polyol is first conveyed into the batch vessel (10) by way of the feed pump (5). A particular embodiment of the agglomerate comninuter (12) having 2 inlets and one outlet is installed within the small loop pipe (32). With the aid of this apparatus, the polyol or the mixture is passed by way of the shut-off valve (13) which is here opened, in a loop out of the batch vessel (10), wherein the filler is taken in simultaneously by way of the filler supply pipe (30) out of the container for receiving or storing the filler (11) and wherein the agglomerates which are present are comminuted in this apparatus in direct manner by a rotor-stator system and are broken up. This is continued until such time as the mixture in the stirring vessel (10) has the desired mixing ratio.

With the aid of the mixture pump (15), with the shut-off valve (14) opened, the mixture can then either be conditioned in the loop by way of the opened shut-off valve (17) or be supplied by way of the opened shut-off valve (18) to the main mixer.

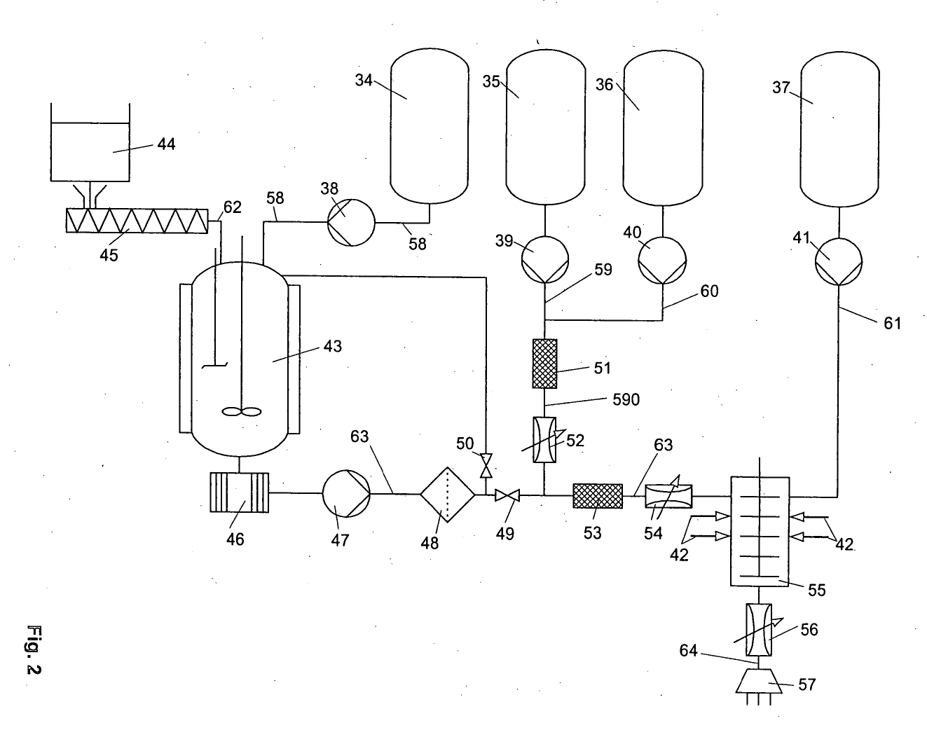

In FIG. 2, a stirring vessel (43) is again built in between the storage vessel for polyol 1 (34) and the mixture pump (47). The desired quantity of polyol is first conveyed by way of the feed pump (38) into the stirring vessel (43). The filler is then conveyed by way of a feed screw (45) from the container for receiving or storing the filler (44) into the stirring vessel (43), until the desired mixing ratio is achieved. This incorporation should here be supported by suitable stirrers.

The mixture can then again with the aid of the mixture pump (47) either be conditioned in the loop by way of the opened shut-off valve (50) or be supplied to the main mixer by way of the opened shut-off valve (49). Here, the apparatus for the comminution of agglomerates (46) is arranged between the stirring vessel (43) and the mixture pump (47). The apparatus for the comminution of agglomerates (46) is based on the rotor-stator principle and on account of its feeding properties serves simultaneously as a supply pump for the mixture pump (47).

As an alternative, the use of one or more nozzles for the purpose of comminution of agglomerates would also be conceivable. Such nozzles would then, however, need to be installed downstream of the mixture pump (47).

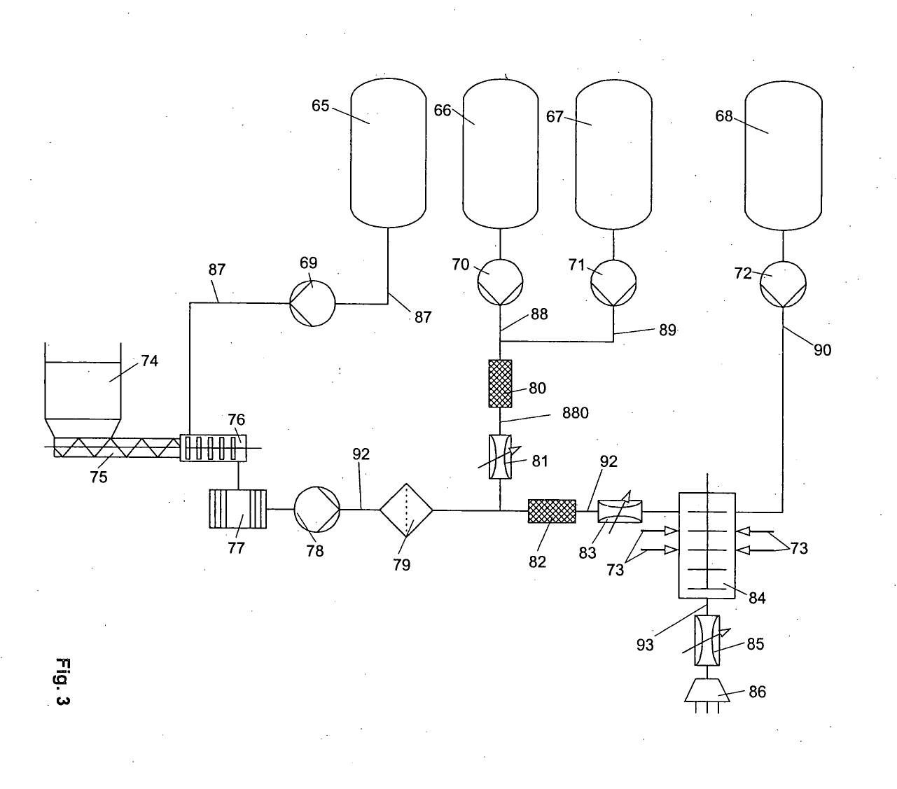

FIG. 3 shows an embodiment of the process of the present invention, in which the filler is added in a continuous and metered manner to the polyol 1 in the way which is described in EP-A-373409, and in which the mixture is then supplied in direct manner to the main mixer (84). The process relies on a combination of a differential metering, achieved by the adjustment of different displaced volumes in the polyol pump (69) and the mixture pump (78), and the control mechanism (not shown here in greater detail), in which the pressure in the premixer (76) is measured and is held constant by way of the rate of revolution of the compression screw (75). While the differential volume adjusted in the pumps makes possible a volumetrically fed addition of the filler, the constant pressure in the premixer (76) guarantees a virtually constant packing density of the filler, as a result of which a mass-fed addition of the filler is achieved overall. Directly downstream of the premixer (76), this mixture is passed through an apparatus for the comminution of agglomerates (77) which relies on the rotor-stator principle.

As an alternative, one or more nozzles for the purpose of comminution of agglomerates could also be used. These nozzles would be installed downstream of the mixture pump.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the continuous production of polyurethane foam from at least one polyol component and at least one isocyanate component using CO₂ as blowing agent comprising:
a) mixing at least one filler with at least a portion of one of the isocyanate or polyol components,
b) exposing the mixture produced in a) to a shear velocity between 10000 s⁻¹ and 200000 s⁻¹ either during or subsequent to mixing to obtain a virtually agglomerate-free mixture,
c) passing the filler-containing mixture through at least one filter element to remove oversize grains, residual agglomerates and/or impurities,
d) adding the CO₂ to at least a portion of one of the isocyanate or polyol components to generate a mixture which comprises liquid CO₂ and optionally filler,
e) mixing the CO₂-containing mixture, the filler-containing mixture and any other reactive component or additive,
f) decompressing the mixture from e) by dividing that mixture into a approximately 3 μm is visualized as processing a quantity of particles on the order plurality of streams having a shear velocity above 500 s⁻¹
g) reducing flow velocity of the streams generated in f),
h) discharging the streams from g) to a substrate, and
i) allowing the discharged material to cure to form a polyurethane foam.

2. The process of claim 1 which further comprises mechanically cleaning at least one filter element used in c).

3. The process of claim 1 in which a two-dimensionally filtering filter element is used in c).

4. The process of claim 3 further comprising cleaning the two-dimensionally filtering filter element mechanically.

5. The process of claim 1 in which the filler is passed through a filter cascade in c).

6. The process of claim 1 in which the finest filter stage used in c) is coarser by a factor of 1 to 10 than the filler's top cut.

7. The process of claim 1 in which the finest filter stage used in c) is coarser by a factor of 1.2 to 7 than the filler's top cut.

8. The process of claim 1 in which the finest filter stage used in c) is coarser by a factor of 1.5 to 5 that the filler's top cut.

9. The process of claim 1 in which the CO₂₋containing mixture and the filler-containing mixture are mixed or combined with each other before mixing with the other component(s).

10. The process of claim 9 in which the pressure of the mixture which comprises CO₂ and filler is reduced before mixing with the other component(s).

11. The process of claim 1 in which the pressure of the reactive mixture is reduced with the aid of an adjustable choke body before discharge.

12. The process of claim 1 in which the filler is supplied by means of a feed screw in continuous manner to a premixer maintained at virtually constant pressure in which the filler and at least portion of the polyol or isocyanate component are mixed.

13. The process of claim 1 in which the filler is taken into the at least portion of the polyol or isocyanate component by low pressure.

14. The process of claim 13 in which the filler is flooded with CO₂ before mixing the filler and at least portion of polyol or isocyanate component so that at least some atmosphere surrounding the filler is replaced by CO₂.

15. The process of claim 12 in which the filler is flooded with CO₂ before mixing the filler and at least portion of polyol or isocyanate component so that at least some atmosphere surrounding the filler is replaced by CO₂.

16. The process of claim 1 in which the filler is pre-sieved before incorporation into at least a portion of the polyol or isocyanate component.

17. An apparatus for the continuous production of polyurethane foam comprising: (1) at least one storage vessel for each of the isocyanate component, polyol component, liquid carbon dioxide and any additive; (2) a feeding device for each of the isocyanate component, polyol component, any additive and liquid carbon dioxide; (3) a main mixer for mixing the isocyanate component and the polyol component; (4) a pipe between each of the storage vessels and the main mixer; (5) at least one container for receiving or storing the filler; (6) an apparatus for the admixture of the filler into the isocyanate component or the polyol component; and (7) an apparatus for comminution of agglomerates in the filler in which
(a) means for transporting filler-containing mixture comprises at least one filter,
(b) a supply pipe coming from the CO₂ storage vessel opens into at least one pipe connecting the storage vessel for the isocyanate component or the polyql component to the main mixer,
(c) a mixing apparatus for mixing-in and dissolution of the CO₂ into the polyol or isocyanate component is arranged between the CO₂ supply pipe where it opens into the isocyanate component or polyol component supply pipe and the main mixer, and
(d) a discharge body which generates a sudden change of pressure comprising at least one fine-meshed sieve is arranged downstream of the main mixer.

18. The apparatus of claim 17 in which the apparatus for the comminution of agglomerates is based on rotor-stator principle.

19. The apparatus of claim 17 in which the apparatus for the comminution of agglomerates comprises at least one nozzle or perforated orifice plate.

20. The apparatus of claim 17 which further comprises a means for mechanically cleaning at least one filter.

21. The apparatus of claim 17 which further comprises a continuous drive for mechanically cleaning at least one filter.

22. The apparatus of claim 17 in which at least one filter comprises a two-dimensionally filtering filter element.

23. The apparatus of claim 17 in which at least one filter having a two-dimensionally filtering filter element comprises an apparatus for mechanical cleaning.

24. The apparatus of claim 17 in which at least one filter having a two-dimensionally filtering filter element and a means for mechanically cleaning comprising a continuous drive are present.

25. The apparatus of claim 17 in which the means for transporting filler-containing mixture comprises at least two filters which are connected in series to form a filter cascade.

26. The apparatus of claim 17 in which the discharge body comprises at least one sieve having openings that in at least one dimension are at least 1.2 to 10 times as large as openings in the finest filter.

27. The apparatus of claim 17 in which the discharge body comprises at least one sieve having openings that in at least one dimension are at least 1.5 to 5 times as large as openings in the finest filter.

28. The apparatus of claim 17 in which the discharge body comprises at least one sieve having openings that in at least one dimension are at least 1.8 to 4 times as large as openings in the finest filter.

29. The apparatus of claim 17 in which the discharge body comprises at least one sieve having hole cross-sections in at least one dimension between 0.03 mm to 1 mm.

30. The apparatus of claim 17 in which the discharge body comprises at least one sieve having hole cross-sections in at least one dimension between 0.07 and 0.7 mm.

31. The apparatus of claim 17 in which the discharge body comprises at least one sieve having hole cross-sections in at least one dimension between 0.3 mm and 0.5 mm.

32. The apparatus of claim 17 in which the discharge body comprises at least two sieves which are consecutive in the direction of flow and are arranged relative to one another so that no hole of the first sieve is aligned with a hole of the second sieve.

33. The apparatus of claim 17 in which an adjustable choke element is positioned between the main mixer and the discharge body.

34. The apparatus of claim 17 in which the means for admixture of the filler includes a premixer and a feed screw embodied as a compression screw.

35. The apparatus of claim 17 in which the means for admixture of the filler comprises a vessel equipped with a stirrer.
